(19) United States
(12) Patent Application Publication
(10) Pub. No.: US 2015/0240061 A1
(43) Pub. Date: Aug. 27, 2015

(54) Soft Stretch Polymer Compositions and Articles

(71) Applicant: ExxonMobil Chemical Patents Inc., Baytown, TX (US)

(72) Inventors: Narayanaswami Raja Dharmarajan, Houston, TX (US); Paul E. Rollin, JR., Porter, TX (US)

(21) Appl. No.: 14/600,868

(22) Filed: Jan. 20, 2015

Related U.S. Application Data
(60) Provisional application No. 61/943,021, filed on Feb. 21, 2014.

(51) Int. Cl. C08L 23/08; B32B 27/12; B32B 27/32; C08J 5/18; B32B 5/02

(52) U.S. Cl. CPC C08L 23/08; C08J 5/18; B32B 5/022; B32B 27/32; B32B 27/12; C08L 2203/16; C08J 2323/08; C08J 2423/02; B32B 2250/03; B32B 2270/00; B32B 2307/51

(57) ABSTRACT

Provided are blend compositions comprising an ethylene copolymer and a polyalphaolefin having soft stretch elastic characteristics. The polymer compositions comprise (a) an ethylene copolymer and (b) from 0.5 wt % to 60 wt % polyalphaolefin. The ethylene copolymer comprises greater than 50 mole % ethylene-derived units and has (i) a density of less than or equal to 0.89 g/cm3, (ii) a Tm of at least 100° C., (iii) a Melt index of less than or equal to 7 dg/min, and (iv) a ΔTm,g of at least 140° C. The polyalphaolefin has (i) a Kinematic viscosity (Kv) at 100° C. of from 3 to 3000 cSt, (ii) a flash point of at least 200° C., and (iii) a pour point of less than or equal to −10° C.

### CROSS REFERENCE TO RELATED APPLICATIONS

This application claims the benefit of priority to U.S. Provisional Application No. 61/943021, filed Feb. 21, 2014, the disclosure of which is fully incorporated herein by reference.

### FIELD OF THE INVENTION

This invention relates to polymer compositions, comprising ethylene copolymers and polyalphaolefins, and to articles, such as films and fabrics, made therefrom.

### BACKGROUND OF THE INVENTION

Ethylene copolymers are well known for their usefulness in a variety of applications, including the manufacture of films and nonwoven fabrics. Such films and fabrics have a wide variety of uses, such as in medical and hygiene products. Elastic laminates, especially those used as diaper waist bands, leg cuffs, and elastic stretch engines, have been constructed from an elastic laminate that comprises a film inner layer with outer fabric or nonwoven facing layers.

In such elastic laminates, the extensibility of the laminate is typically governed to a large extent by the properties of the elastic film layer. For diaper applications there is a customer preference for a soft-stretch, where the laminate when extended shows a load that increases initially but remains relatively unchanged with additional extension. Soft-stretch laminates are particularly desirable for infant diaper applications, so that when an adult fastens the diaper on the infant they will not need to apply a high force to extend the elastic laminate. There is a need, therefore, for polymer compositions suitable for producing elastic laminates having improved soft-stretch performance.

Background references include: U.S. Patent Publication No. 2009/0068427 that describes multi-layer elastic articles comprising at least a low crystallinity layer and a high crystallinity layer; PCT Publication No. WO 2011/112309 describing a method for producing temperature resistant nonwovens; PCT Publication Nos. WO 2012/088384 and WO 2011/022523 that describe hot melt adhesives; and U.S. Patent Publication No. 2006/0173123 that describes polyethylene polymer compositions with liquid hydrocarbon modifiers.

### BRIEF DESCRIPTION OF THE FIGURES

FIG. 1 illustrates a typical first cycle hysteresis curve and key result parameters.

FIG. 2 illustrates the first cycle hysteresis curves for control composition C1 as well as curves for example blends E1, E2, and E3.

FIG. 3 illustrates the first cycle hysteresis curves for control composition C2 as well as curves for example blends E4, E5, and E6.

FIG. 4 illustrates the first cycle hysteresis curves for control composition C1 as well as curves for example blends E2, E7, and E8.

### SUMMARY OF THE INVENTION

Provided herein are polymer compositions comprising ethylene copolymer and polyalphaolefin. The ethylene copolymer comprises greater than 50 mole % ethylene and has (i) a density less than or equal to 0.89 g/cm3, (ii) a melting temperature (“Tm”) of at least 100° C., (iii) a Melt index less than or equal to 7 dg/min, and (iv) a difference between the second melt peak temperature and the glass transition temperature (“ΔTm,g”) of at least 140° C. The polymer composition comprises from 0.5 wt % to 60 wt % polyalphaolefin, where the polyalphaolefin has (i) a Kinematic viscosity (“Kv”) at 100° C. of from 3 to 3000 cSt, (ii) a flash point of at least 200° C., and (iii) a pour point up to −10° C.

The polymer compositions exhibiting soft stretch may have a 50% loading force during a 100% hysteresis cycle at least 6% lower than a similar composition containing the same ethylene copolymer except that the similar composition contains no polyalphaolefin and the two compositions are tested under the same conditions.

The polymer compositions exhibiting soft stretch may have a 100% loading force during a 100% hysteresis cycle at least 9% lower than a similar composition containing the same ethylene copolymer except that the similar composition contains no polyalphaolefin and the two compositions are tested under the same conditions.

### DETAILED DESCRIPTION OF THE INVENTION

Described herein are polymer blend compositions comprising ethylene copolymers and polyalphaolefins with optional modifiers and additives. The blend compositions may be useful in making films, fibers, and nonwoven laminates and compositions. In particular, the blend compositions may be useful in making stretch films for hygiene laminate applications.

As used herein, the term “copolymer” is meant to include polymers having two or more monomers, optionally, with other monomers, and may refer to interpolymers, terpolymers, etc. The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic and random symmetries.

The term “blend” as used herein refers to a mixture of two or more polymers.

The term “monomer” or “comonomer,” as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”. Different monomers are discussed herein, including propylene monomers, ethylene monomers, and diene monomers.

As used herein, the term “ethylene copolymer,” means copolymers comprising ethylene and an alphaolefin having 4 or more carbon atoms, such as 4-12 carbon atoms, or 6-10 carbon atoms. In preferred embodiments, the ethylene copolymer comprises ethylene and octene-derived units. In the ethylene copolymer, ethylene comprises the majority mole fraction of the polymer, i.e., the copolymer comprises at least 50 mole % of ethylene-derived units. More preferably the copolymer comprises at least about 60 mole %, at least about 70 mole %, or at least about 80 mole % ethylene-derived units. The remainder of the polymer comprises comonomer-derived units. For example, the copolymer may comprise at least 5 mole %, or at least 10 mole %, or 15 mole % comonomer-derived units. In some embodiments, the ethylene copolymer comprises at least about 80 mole % ethylene-derived units and from about 10 to about 20 mole %, preferably from about 15 to about 20 mole % octene-derived units.

“Polypropylene,” as used herein, includes homopolymers and copolymers of propylene or mixtures thereof. Products that include one or more propylene monomers polymerized with one or more additional monomers may be more commonly known as random copolymers (RCP) or impact copolymers (ICP). Impact copolymers may also be known in the art as heterophasic copolymers. “Propylene-based,” as used herein, is meant to include any polymer comprising propylene, either alone or in combination with one or more comonomers, in which propylene is the major component (i.e., greater than 50 wt % propylene).

As used herein, an “EP Rubber” is defined to be a copolymer of ethylene and propylene, and optionally diene monomer(s), chemically crosslinked (i.e., cured) or not, where the ethylene content is from 35 to 80 wt %, the diene content is 0 to 15 wt %, and the balance is propylene. The copolymer may have a Mooney viscosity, ML(1+4)@125° C. (measured according to ASTM D1646) of 15 to 100. The terms “EPDM” or “EPDM Rubber,” as used herein, are defined to be an EP Rubber having diene present.

A “liquid,” as used herein, is defined to be a fluid that has no distinct melting point above 0° C., preferably no distinct melting point above −20° C. A liquid preferably also has a kinematic viscosity at 100° C. of 3000 cSt or less, or 1000 cSt or less, and/or a kinematic viscosity at 40° C. of 35,000 cSt or less, or 10,000 cSt or less.

As used herein, “nonwoven fabric” means a web structure of individual fibers or filaments that are interlaid, but not in an identifiable manner as in a knitted fabric.

As used herein, “melt[ing] temperature” (“Tm”) is measured using Differential Scanning calorimetry (DSC). This analysis is conducted using either a TA Instruments MDSC 2920 or a Perkin Elmer DSC7. Typically, 6 to 10 mg of molded polymer or modified polymer composition was sealed in an aluminum pan and loaded into the instrument at room temperature. Melting data (first heat) were acquired by heating the sample to at least 30° C. above its melting temperature at a heating rate of 10° C./min. This provides information on the melting behavior under as-molded conditions, which can be influenced by thermal history as well as any molded-in orientation or stresses. The sample was then held for 10 minutes at this temperature to destroy its thermal history. Crystallization data was acquired by cooling the sample from the melt to 25° C. at a cooling rate of 10° C./min. The sample was then held at 25° C. for 10 minutes, and finally heated at 10° C./min to acquire additional melting data (second heat). This provides information about the melting behavior after a controlled thermal history and free from potential molded-in orientation and stress effects. The endothermic melting transition (first and second heat) and exothermic crystallization transition were analyzed for onset of transition and peak temperature. The melting temperatures reported in the tables are the peak melting temperatures from the second heat unless otherwise indicated. For polymers displaying multiple peaks, the higher melting peak temperature is reported.

As used herein, the “glass transition temperature” (T_{g}) is measured using dynamic mechanical analysis. This test provides information about the small-strain mechanical response of a sample as a function of temperature over a temperature range that includes the glass transition region and the visco-elastic region prior to melting. Specimens are tested using a commercially available DMA instrument (e.g., TA Instruments DMA 2980 or Rheometrics RSA) equipped with a dual cantilever test fixture. The specimen is cooled to −130° C. then heated to 60° C. at a heating rate of 2° C./min while subjecting to an oscillatory deformation at 0.1% strain and a frequency of 6.3 rad/sec. The output of these DMA experiments is the storage modulus (E′) and loss modulus (E″). The storage modulus measures the elastic response or the ability of the material to store energy, and the loss modulus measures the viscous response or the ability of the material to dissipate energy. Tg is defined to be the temperature associated with peak loss modulus (E″).

### Ethylene Copolymers

The ethylene copolymers comprise ethylene and an alphaolefin having 4 or more carbon atoms. Preferably the ethylene copolymer comprises an alphaolefin having 4-12 carbon atoms, or 6-10 carbon atoms. In some preferred embodiments, the ethylene copolymer comprises octene as the alpha-olefin. The ethylene copolymer comprises a majority mole fraction of ethylene-derived units, i.e., the ethylene copolymer comprises at least about 50 mole % of ethylene-derived units. More preferably the ethylene copolymer comprises at least about 60 mole %, at least about 70 mole %, or at least about 80 mole % ethylene-derived units, with the remainder of the ethylene copolymer comprising at least one other comonomer. For example, the ethylene copolymer may comprise at least 5 mole %, or at least 10 mole %, or at least 15 mole % comonomer-derived units. The ethylene copolymer may comprise less than 40 mole %, or less than 35 mole %, or less than 30 mole %, or less than 25 mole %, or less than 20 mole % comonomer. In preferred embodiments, the ethylene copolymer is an ethylene/octene copolymer that comprises at least 80 mole % ethylene-derived units and from about 10 to about 20 mole %, preferably from about 15 to about 20 mole % octene-derived units.

The ethylene copolymers have a density less than or equal to 0.89 g/cm³, for example less than or equal to 0.885, or less than or equal to 0.882 g/cm³, or less than or equal to 0.88 g/cm³, or less than or equal to 0.87 g/cm³. The ethylene copolymers also have a density of at least 0.84 g/cm³, or at least 0.85 g/cm³, at least 0.86 g/cm³, or at least 0.866 g/cm³. The ethylene copolymers may have a density range of from 0.84 to 0.89 g/cm³, or 0.85 to 0.88 g/cm³, or 0.86 to 0.87 g/cm³. The density of the ethylene copolymer may be measured by ASTM D792.

The ethylene copolymers have a melt index (MI) less than or equal to 7 dg/min, or less than or equal to 6.5 dg/min, or less than or equal to 6 dg/min, or less than or equal to 5.5 dg/min, or less than or equal to 5 dg/min, as measured using ASTM D1238 with a 2.16 kg weight at 190° C. The ethylene copolymer may have a MI of at least 0.5 dg/min, or at least 0.75 dg/min, or at least 1 dg/min, or at least 2 dg/min.

The ethylene copolymers have a melting temperature (Tm, second melt peak) of at least 100° C., or at least 105° C., or at least 110° C., or at least 115° C., or at least 120° C., as determined by the DSC test method described above. The ethylene copolymer may have a Tm of less than 175° C., or less than 170° C., or less than 165° C., or less than 160° C., or less than 155° C., or less than 150° C., or less than 145° C., or less than 140° C., or less than 135° C., or less than 130° C.

The ethylene copolymers have a glass transition temperature (Tg) of less than −40° C., or less than −45° C., or less than −50° C., or less than −55° C., as determined by DMA as described above. The ethylene copolymer may have a Tg of greater than −80° C., or −75° C., or −70° C., or −65° C., or −60° C.

The ethylene copolymers have a compression set up to 80%, or up to 75%, or up to 70%, or up to 60%, or up to 50%, as determined by ASTM D395 at 70° C. The ethylene copolymer may have a compression set of at least 30%, or at least 35%, or at least 40%, or at least 45%.

The ethylene copolymers have a tensile modulus (100% Secant) less than or equal to 4 MPa, or less than or equal to 3.5 MPa, or less than or equal to 3.0 MPa, or less than or equal to 2.5 MPa, or less than or equal to 2.0 MPa, or less than or equal to 1.6 MPa, as determined by ASTM D638. The ethylene copolymer may have a 100% Secant tensile is modulus of at least 0.5 MPa, or at least 0.75 MPa, or at least 1.0 MPa, or at least 1.25 MPa, or at least 1.5 MPa.

The ethylene copolymers have a Shore hardness (A scale) of 50 to 80, or from 55 to 75, or from 55 to 65, as measured by ASTM D 2240.

The ethylene copolymers have a difference between the second melt peak temperature and the glass transition temperature (Tm−Tg, hereinafter “ΔTm,g”) that is at least 140° C. In preferred embodiments, the ethylene copolymers have a ΔTm,g of at least 145° C., or at least 150° C., or at least 155° C., or at least 160° C., or at least 165° C., or at least 170° C., or at least 175° C. The ethylene copolymer may have a ΔTm,g of less than 250° C., or less than 225° C., or less than 200° C., or less than 195° C., or less than 190° C., or less than 185° C.

In some embodiments, blends of two or more ethylene copolymers may be used. For example, a blend of a first ethylene copolymer and a second ethylene copolymer may be employed, where the second ethylene copolymer is different from the first ethylene copolymer in at least one way, for example in comonomer content, in type of comonomer, in density, in melting temperature, or in glass transition temperature.

Useful ethylene copolymers may include certain grades of polymers sold by Dow Chemical Company under the Infuse™ tradename. Such ethylene copolymers are described in U.S. Pat. Nos. 7,355,089 and 7,608,668; U.S. Patent Application Publication Nos. 2009/0068427 and 2009/0247033; and PCT Publication Nos. WO 2006/101966 and WO 2006/102016, the disclosures of which are incorporated herein by reference.

### Polyalphaolefin

Polyalphaolefins (PAOs) are oligomers of α-olefins (also known as 1-olefins). A PAO may be characterized by any type of tacticity, including isotactic or syndiotactic and/or atactic, and by any degree of tacticity, including isotactic-rich or syndiotactic-rich or fully atactic. PAO liquids are described in, for example, U.S. Pat. Nos. 3,149,178; 4,827,064; 4,827,073; 5,171,908; and 5,783,531; and in SYNTHETIC LUBRICANTS AND HIGH-PERFORMANCE FUNCTIONAL FLUIDS, Leslie R. Rudnick & Ronald L. Shubkin, eds. (Marcel Dekker, 1999), pp. 3-52. PAOs are Group 4 compounds, as defined by the American Petroleum Institute (API).

Useful PAOs may be made by any suitable means known in the art. For example, the PAOs may be prepared by the oligomerization of an α-olefin in the presence of a polymerization catalyst, such as a Friedel-Crafts catalyst (including, for example, AlCl₃, BF₃, is and complexes of BF₃ with water, alcohols, carboxylic acids, or esters), a coordination complex catalyst (including, for example, the ethylaluminum sesquichloride+TiCl₄ system), or a homogeneous or heterogeneous (supported) catalyst more commonly used to make polyethylene and/or polypropylene (including, for example, Ziegler-Natta catalysts, metallocene or other single-site catalysts, and chromium catalysts). Subsequent to the polymerization, the PAO may be hydrogenated in order to reduce any residual unsaturation. PAO's may be hydrogenated to yield substantially (greater than 99 wt %) paraffinic materials. The PAO's may also be functionalized to comprise, for example, esters, polyethers, polyalkylene glycols, and the like.

The percentage of carbons in chain-type paraffinic structures (C_{P}) is close to 100% (typically greater than 98% or even 99%) for PAOs.

In general, PAOs are high purity hydrocarbons with a paraffinic structure and a high-degree of side-chain branching. The PAO may have irregular branching or regular branching. The PAO may comprise oligomers or low molecular weight polymers of branched and/or linear alpha olefins. In some embodiments, the PAO comprises C₆ to C₂₀₀₀, or C₈ to C₁₅₀₀, or C₁₀ to C₁₀₀₀, or C₁₅ to C₈₀₀, or C₂₀ to C₄₀₀, or C₃₀ to C₂₅₀ oligomers of α-olefins. These oligomers may be dimers, trimers, tetramers, pentamers, etc. In some embodiments, the PAO comprises C₂ to C₂₄, preferably C₅ to C₁₈, more preferably C₆ to C₁₄, even more preferably C₈ to C₁₂, most preferably C₁₀ branched or linear α-olefins. In some embodiments, the PAO comprises C₃ to C₂₄, preferably C₅ to C₈, more preferably C₆ to C₁₄, most preferably C₈ to C₁₂ linear α-olefins (LAOs). Suitable olefins include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, and blends thereof. Oligomers of LAOs with only even carbon numbers between 6 and 18 (inclusive) are particularly preferred. Preferably C₂, C₃, and C₄ α-olefins (i.e., ethylene, propylene and 1-butene and/or isobutylene) are present in the PAO oligomers at an average concentration of 30 wt % or less, or 20 wt % or less, or 10 wt % or less, or 5 wt % or less; more preferably C₂, C₃, and C₄ α-olefins are not present in the PAO oligomers.

In some embodiments, the PAO comprises oligomers of a single LAO or a single α-olefin species. For example, the PAO may comprise oligomers of a single α-olefin species having a carbon number of 5 to 24 (preferably 6 to 18, preferably 8 to 12, or preferably 10). For example, the PAO may be formed by the oligomerization of 1-decene, and the PAO is a mixture of oligomers (including, for example, dimers, trimers, tetramers, pentamers, and higher) of 1-decene.

In some embodiments, the PAO may comprise a blend of oligomers of two or more LAOs or oligomers of mixed α-olefins (i.e., involving two or more a-olefin species). For example, the PAO may comprise a blend of oligomers of two or more C₃ to C₂₄ α-olefins, or C₅ to C₂₄ α-olefins, or C₆ to C₁₈ α-olefins, or C₈ to C₁₂ α-olefins (inclusive of C₈ and C₁₂). Thus, in some embodiments, the mixture of α-olefins may be used to make ‘bipolymer’ or ‘terpolymer’ or higher-order copolymer combinations, provided that C₃ and C₄ LAOs are present at 10 wt % or less. For example, in some embodiments the PAO may comprise oligomers of mixed α-olefins where the weighted average carbon number for the α-olefin mixture is 6 to 14 (preferably 8 to 12, preferably 9 to 11). In some preferred embodiments, the PAO comprises an oligomerization of a mixture of 1-octene, 1-decene, and 1-dodecene, and the PAO is a mixture of oligomers (for example, dimers, trimers, tetramers, pentamers, and higher) of 1-octene/1-decene/1-dodecene ‘terpolymer’.

In another embodiment, the PAO comprises oligomers of one or more α-olefin with repeat unit formulas of:

—[CHR—CH₂]—

where R is a C₃ to C₁₈ saturated hydrocarbon branch. Preferably R is constant for all oligomers. In another embodiment, there is a range of R substituents covering carbon numbers from 3 to 18. Preferably R is linear, i.e.,

R is (CH₂)_{z}CH₃,

where z is 2 to 17 (preferably 3 to 11, preferably 4 to 9).

Optionally, R may contain one methyl or ethyl branch, i.e.,

R is (CH₂)ₘ[CH(CH₃)](CH₂)ₙCH₃ or (CH₂)ₓ[CH(CH₂CH₃)](CH₂)_{y}CH₃,

where (m+n) is 1 to 15 (preferably 1 to 9, preferably 3 to 7) and (x+y) is 1 to 14 (preferably 1 to 8, preferably 2 to 6). Preferably m greater than n. Preferably m is 0 to 15 (preferably 2 to 15, preferably 3 to 12, preferably 4 to 9) and n is 0 to 10 (preferably 1 to 8, preferably 1 to 6, preferably 1 to 4). Preferably x greater than y. Preferably x is 0 to 14 (preferably 1 to 14, preferably 2 to 11, preferably 3 to 8) and y is 0 to 10 (preferably 1 to 8, preferably 1 to 6, preferably 1 to 4). Preferably the repeat units are arranged in a head-to-tail fashion with minimal heat-to-head connections.

The PAO may be atactic, isotactic, or syndiotactic. In one embodiment, the PAO has essentially the same population of meso [m] and racemic [r] dyads (preferably neither [m] nor [r] greater than 60%, preferably neither greater than 55%) as measured by ¹³C-NMR, making it atactic. In another embodiment, the PAO has more than 60% (preferably more than 70%, preferably more than 80%, preferably more than 90%) meso dyads [m]. In another is embodiment, the PAO has more than 60% (preferably more than 70%, preferably more than 80%, preferably more than 90%) racemic dyads [r]. In one embodiment, [m]/[r] determined by ¹³C-NMR is between 0.9 and 1.1 in one embodiment, [m]/[r] is greater than 1 in another embodiment, and [m]/[r] is less than 1 in yet another embodiment.

Preferred PAOs have a “branching ratio” as defined in U.S. Pat. No. 4,827,064 and measured according to the method described therein, of 0.20 or less, preferably 0.19 or less, preferably 0.18 or less, preferably 0.17 or less, preferably 0.15 or less, preferably 0.12 or less, preferably 0.10 or less.

The PAO may have a number average molecular weight (Mₙ) in the range of 1.00×10² to 2.10×10⁴ g/mole or 3.00×10² to 1.50×10⁴ g/mole, or in the range of 2.00×10² to 1.00×10⁴, or 2.00×10² to 7.00×10³, or 6.00×10² to 3.00×10³, or 2.00×10² to 2.00×10³, or 2.00×10² to 5.00×10² g/mole.

The PAOs may have a weight average molecular weight (M_{w}) of less than 10,000 g/mole, or less than 5,000 g/mole, or less than 4,000 g/mole, or less than 2,000 g/mole, or less than 1,000 g/mole. In some embodiments, the PAO may have an M_{w} of 250 g/mole or more, 400 g/mole or more, or 500 g/mole or more, or 600 g/mole or more, or 700 g/mole or more, or 750 g/mole or more. In some embodiments, the PAO may have a Mw in the range of from 250 to 10,000 g/mole, or from 400 to 5,000 g/mole, or form 500 to 4,000 g/mole, or from 600 to 2000 g/mole, or from 700 to 1000 g/mole.

Useful PAOs have a kinematic viscosity (“KV”) at 100° C., as measured by ASTM D445 at 100° C., of at least 3 cSt (1 cSt=1 mm²/s), or at least 4 cSt, or at least 5 cSt, or at least 6 cSt, or at least 7 cSt, or at least 8 cSt, or at least 9 cSt, or greater than or equal to 10 cSt. The PAO may have a KV at 100° C. of less than 3000 cSt, or less than 1000 cSt, or less than 500 cSt, or less than 300 cSt, or less than 200 cSt, or less than 150 cSt, or less than 125 St, or less than 100 cSt, or less than 90 cSt, or less than 80 cSt, or less than 70 cSt, or less than 60 cSt, or less than 50 cSt, or less than 40 cSt, or less than 30 cSt, or less than 20 cSt. For example, the PAO may have a KV at 100° C. of from 3 to 3,000 cSt, 4 to 1,000 cSt, 6 to 300 cSt, 8 to 125 cSt, 8 to 100 cSt, or 10 to 60 cSt. In some embodiments, the PAO has a KV at 100° C. of 5 to 1000 cSt, preferably 6 to 300 cSt, preferably 7 to 100 cSt, or 8 to 50 cSt.

Useful PAOs have a kinematic viscosity (“KV”) as measured by ASTM D445 at 40° C. of less than 500 cSt, or less than 300 cSt, or less than 200 cSt, or less than 150 cSt, or less than 125 cSt, or less than 100 cSt, or less than 95 cSt, or less than 90 cSt, or less than 85 cSt, or less than 80 cSt, or less than 75 cSt, or less than 70 cSt. The PAO may have a KV at is 40° C. of at least 5 cSt, or at least 10 cSt, or at least 15 cSt, or at least 20 cSt, or at least 25 cSt, or at least 30 cSt, or at least 35 cSt, or at least 40 cSt, or at least 45 cSt, or at least 50 cSt, or at least 55 cSt, or at least 60 cSt. For example, the PAO may have a KV at 40° C. of from 5.0 to about 500 cSt, about 10 to 300 cSt, or 20 to 200 cSt, or 30 to 100 cSt, or 40 to 80 cSt, or 50 to 75 cSt.

The PAOs may also have a viscosity index (“VI”), as determined by ASTM D2270, of at least 50, or at least 60, or at last 70, or at least 80, or at least 90, or at least 100, or at least 110, or at least 115, or at least 120, or at least 125, or at least 130, or at least 135. The PAO may have a VI of less than 400, or less than 375, or less than 350, or less than 325, or less than 300, or less than 275, or less than 250, or less than 225, or less than 200, or less than 175, or less than 170, or less than 160, or less than 150. For example, the PAO may have a VI of from 50 to 400, or 60 to 350, or 70 to 250, or 80 to 200, or preferably 90 to 175, or 100 to 150.

The PAO may have a pour point of less than 0° C., or less than −10° C., or less than −15° C., or less than −20° C., or less than −25° C., or less than −30° C., or less than −35° C., or less than −40° C., or less than −45° C. The PAO may have a pour point of at least −100° C., or at least −90° C., or at least −85° C., or at least −80° C., or at least −75° C., or at least −70° C., or at least −65° C., or at least −60° C., or at least −55° C., or at least −50° C. For example, the PAO may have a pour point of −100° C. to 0° C., −100° C. to −10° C., −90° C. to −15° C., −80° C. to −20° C. In some embodiments, the PAO or blend of PAOs has a pour point of −25° C. to −75° C., preferably −40° C. to −60° C.

The PAO may have a flash point of 150° C. or more, 200° C. or more, 210° C. or more, 220° C. or more, 230° C. or more. The PAO may have a flash point of less than 400° C., or less than 375° C., or less than 350° C., or less than 325° C., or less than 300° C., or less than 290° C., or less than 280° C., or less than 270° C. For example, the PAO may have a flash point of between 240° C. and 290° C.

The PAO may have a specific gravity (15.6/15.6° C., 1 atm/1 atm) of 0.79 to 0.90, preferably 0.80 to 0.89, preferably 0.81 to 0.88, preferably 0.82 to 0.87, and 0.83 to 0.86, where the range may comprise the combination of any lower limit and any upper limit recited herein.

Particularly preferred PAOs are those having (a) a flash point of 200° C. or more, 210° C. or more, 220° C. or more, or 230° C. or more; and (b) a pour point less than −10° C., less than −20° C., less than −25° C., less than −30° C., less than −35° C., or less than −40° C., and is (c) a KV at 100° C. of 2 cSt or more, 4 cSt or more, 5 cSt or more, 6 cSt or more, 8 cSt or more, or 10 cSt or more.

Further preferred PAOs have a KV at 100° C. at least 5 to 50 cSt, particularly 8 to 20 cSt; a pour point of −25° C. to −75° C., preferably −40° C. to −60° C.; and a specific gravity of 0.81 to 0.87, preferably 0.82 to 0.86.

The PAO may be comprised of one or more distinct PAO components. In one embodiment, the PAO is a blend of one or more oligomers with different compositions (e.g., different α-olefin(s) were used to make the oligomers) and/or different physical properties (e.g., KV, pour point, VI, and/or T_{g}).

Useful PAOs are available include certain grades of SpectraSyn™ and SpectraSyn Ultra™ available from ExxonMobil Chemical Company (Houston, Tex., USA). Other useful PAOs include certain grades of Synfluid™ available from ChevronPhillips Chemical Company (Pasadena, Tex., USA), Durasyn™ available from Innovene (Chicago, Ill., USA), Nexbase™ available from Neste Oil (Keilaniemi, Finland), and Synton™ available from Chemtura Corporation (Middlebury, Conn., USA).

### Blend Compositions

The polymer blend compositions comprise ethylene copolymers and polyalphaolefins with optional modifiers and additives. The polymer blends described herein are physical blends or in situ blends of more than one type of ethylene copolymer or blends of ethylene copolymers with polymers other than ethylene copolymers where the ethylene copolymer component is the majority component (greater than 50 wt %).

Blend compositions may comprise at least one ethylene copolymer and at least one PAO. In some embodiments, the blend compositions may comprise one ethylene copolymer and one PAO, while in other embodiments, the blend composition may comprise a blend of ethylene copolymers blended with one PAO, or one ethylene copolymer blended with a blend of PAOs, or blends of ethylene copolymers blended with a blend of PAOs.

The blend composition may comprise, at least about 0.5 wt % PAO, or at least about 1 wt % PAO, or at least about 2 wt % PAO, or at least about 3 wt % PAO, or at least about 4 wt % PAO, or at least about 5 wt % PAO, or at least about 6 wt % PAO, or at least about 7 wt % PAO, or at least about 8 wt % PAO, or at least about 9 wt % PAO, or at least about 10 wt % PAO, based on the weight of the blend composition. The blend composition may comprise up to about 60 wt % PAO, or up to about 55 wt % PAO, or up to about 50 wt % PAO, or up to about 45 wt % PAO, or up to about 40 wt % PAO, or up to about 35 wt % PAO, is or up to about 30 wt % PAO, or up to about 25 wt % PAO, or up to about 20 wt % PAO, or up to about 15 wt % PAO, based on the weight of the blend composition.

In some embodiments the blend composition may comprise from about 0.5 to 60 wt % PAO, or from about 1 to 50 wt % PAO, or from about 2 to 45 wt % PAO, or from about 5 to 40 wt % PAO. In some embodiments, the blend composition is a lean blend and may comprise from about 0.5 to 20 wt % PAO, or from about 1 to 15 wt % PAO, or from about 2 to 10 wt % PAO, or from about 5 to 9 wt % PAO. In other embodiments, the blend composition is a concentrated blend and may comprise from about 10 to about 60 wt % PAO, or from about 15 to 50 wt % PAO, or from about 20 to 45 wt % PAO, or from about 30 to 45 wt % PAO.

The blend composition has improved soft-stretch as compared to compositions comprising similar ethylene copolymers but that do not contain the PAO. For example, the blend composition has a 50% loading force during a 100% hysteresis cycle at least 6%, 7%, 9%, 11%, 14%, 16%, 17%, 23%, 25%, 27%, 33%, or 35% lower than a similar composition containing an ethylene copolymer but that contains no PAO.

The blend composition has a 100% loading force during a 100% hysteresis cycle at least 9%, 11%, 15%, 16%, 25%, or 27% lower than a similar composition containing an ethylene copolymer but that contains no PAO.

In some embodiments, the blend composition may additionally include 25 wt % or less of one or more other polymer modifiers, including but not limited to, thermoplastic polymer(s) and/or elastomer(s).

By “thermoplastic polymer(s)” is meant a polymer that can be melted by heat and then cooled without appreciable change in solid-state properties before and after heating. Thermoplastic polymers typically include, but are not limited to, polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Preferred polyolefins include, but are not limited to, polymers comprising one or more linear, branched or cyclic C₂ to C₄₀ olefins, preferably polymers comprising ethylene copolymerized with one or more C₃ to C₄₀ olefins, preferably a C₃ to C₂₀ alpha olefin, more preferably C₃ to C₁₀ alpha-olefins. A particularly preferred example is polybutene. The most preferred polyolefin is polypropylene. Other preferred polyolefins include, but are not limited to, polymers comprising ethylene including but not limited to ethylene copolymerized with a C₃ to C₄₀ olefin, preferably a C₃ to C₂₀ alpha olefin, more preferably propylene, butene, hexene, and/or octene.

By “elastomers” is meant all natural and synthetic rubbers, including those defined in ASTM D1566. Examples of preferred elastomers include, but are not limited to, ethylene propylene rubber, ethylene propylene diene monomer rubber, styrenic block copolymer rubbers (including SEBS, SI, SIS, SB, SBS, SIBS and the like, where S=styrene, EB=random ethylene+butene, I=isoprene, and B=butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber (both cis and trans).

In some embodiments, the blend comprising the PAO may further be combined with one or more polymers polymerizable by a high-pressure free radical process, polyvinylchloride, polybutene-1, isotactic polybutene, ABS resins, block copolymer, styrenic block copolymers, polyamides, polycarbonates, PET resins, crosslinked polyethylene, copolymers of ethylene and vinyl alcohol (EVOH), polymers of aromatic monomers such as polystyrene, poly-1 esters, polyacetal, polyvinylidine fluoride, polyethylene glycols and/or polyisobutylene.

In another embodiment the blend comprises 25 wt % or less of a propylene-based polymer (i.e., polymers that contain greater than 50 mole % propylene-derived units), 20 wt % or less, 15 wt % or less, 10 wt % or less, or 5 wt % or less. In some embodiments the blend composition is substantially free of propylene-based polymers (i.e., polymers that contain greater than 50 mole % propylene-derived units), or contains less than 5 wt % of propylene-based polymers, or contains 0 wt % of intentionally added propylene-based polymers.

A variety of additives may be incorporated into the blend compositions described herein, depending upon the intended purpose. For example, when the blends are used to form films, fibers, and nonwoven fabrics, such additives may include but are not limited to stabilizers, antioxidants, fillers, colorants, nucleating agents, dispersing agents, mold release agents, slip agents, fire retardants, plasticizers, pigments, vulcanizing or curative agents, vulcanizing or curative accelerators, cure retarders, processing aids, tackifying resins, and the like. Other additives may include fillers and/or reinforcing materials, such as carbon black, clay, talc, calcium carbonate, mica, silica, silicate, combinations thereof, and the like. Primary and secondary antioxidants include, for example, hindered phenols, hindered amines, and phosphates. Nucleating agents include, for example, sodium benzoate and talc. Also, to improve crystallization rates, other nucleating agents may also be employed such as Ziegler-Natta olefin products or other highly crystalline polymers. Other additives such as dispersing agents, for example, Acrowax C, can also be included. Slip agents include, for example, oleamide and erucamide. Catalyst deactivators are also commonly used, for example, calcium stearate, hydrotalcite, and calcium oxide, and/or other acid neutralizers known in the art.

Further, in some embodiments, additives may be incorporated into the blend compositions directly or as part of a masterbatch, i.e., an additive package containing several additives to be added at one time in predetermined proportions. The masterbatch may be added in any suitable amount to accomplish the desired result. For example, a masterbatch comprising an additive may be used in an amount ranging from about 0.1 to about 10 wt %, or from about 0.25 to about 7.5 wt %, or from about 0.5 to about 5 wt %, or from about 1 to about 5 wt %, or from about 2 to about 4 wt %, based on the total weight of the polymer blend and the masterbatch.

### Methods for Preparing the Blend Composition

The blend compositions described herein may be formed by combining the ethylene copolymer and the polyalphaolefin, and other optional fillers and additives using any suitable means known in the polymer processing art. Those skilled in the art will be able to determine the appropriate methods to enable intimate mixing while also achieving process economy. For example, the components may be blended in a tumbler, continuous mixer, static mixer, batch mixer, extruder, or a combination thereof that is sufficient to achieve an adequate dispersion of the components.

In some embodiments, the blend composition may be prepared by combining the ethylene copolymer and PAO components during a process used to fabricate articles, without first making a pelletized version of the composition. For example, the PAO may be added to other components in a production extruder, such as the extruder on an injection molding machine or on a continuous extrusion line, and thereafter directly processed into a film, sheet, fiber, profile, etc.

In other preferred embodiments, the blend composition is prepared by a method that comprises combining the ethylene copolymer and PAO components and then pelletizing the blend compositions. Without being bound by theory, it is believed that, by pelletizing the blend composition before forming the fabricated article that a more uniform dispersion of the PAO within the ethylene copolymer is achieved. This in turn allows for a more uniform dispersion of the PAO within the fabricated article, allowing for the improvements in softness of stretch described herein. Therefore, in some embodiments, the fabricated article may be prepared by a method comprising the steps of: (a) combining (i) an ethylene copolymer and (ii) a polyalphaolefin to form a blend; (b) pelletizing the blend to form a pellet composition; and (c) using the pellet composition to form a fabricated article.

In some embodiments, the ethylene copolymer and PAO components may be combined in a melt-blending (compounding) step and subsequently pelletizing the blend, using either an underwater pelletizer or a strand-cut approach (i.e., a water batch and dry pelletizer). This approach may involve an on-line “finishing” extruder associated with a polymerization unit, or it may involve an off-line “compounding” extruder dedicated to melt blending.

In some embodiments, the method of blending the components may be to melt-blend the components in a batch mixer, such as a Banbury™ or Brabender™ mixer.

In some embodiments, the method of blending may be to melt blend the components in an extruder, such as a single-screw extruder or a twin-screw extruder. Extrusion technology for polymer blends is well known in the art, and is described in more detail in, for example, PLASTICS EXTRUSION TECHNOLOGY, F. Hensen, Ed. (Hanser, 1988), pp. 26-37, and in POLYPROPYLENE HANDBOOK, E. P. Moore, Jr. Ed. (Hanser, 1996), pp. 304-348.

The PAO may be directly injected into the polymer melt using a liquid injection device at some point along the barrel, as in the case of a twin-screw extruder, or through an opening in a hollow screw shaft, as in the case of a single-screw extruder. PAO is preferably added downstream from the polymer melt zone, but alternatively the PAO can be added at a point where the polymer(s) have not fully melted yet. For example, in a twin-screw extruder, PAO can be injected after the first barrel section (preferably after the first third of the barrel, more preferably in the last third of the barrel). A PAO addition point may be on top of conveying elements of screw, or on top of liquid mixing elements of screw, or prior to kneading elements of screw, or prior to liquid mixing elements of the screw. The extruder may have more than one (preferably two or three) PAO addition points along the barrel or screw shaft. Optionally, the PAO can be added via the extruder feed throat.

The components may also be blended by a combination of methods, such as dry blending followed by melt blending in an extruder, or batch mixing of some components followed by melt blending with other components in an extruder. One or more components is may also be blended using a double-cone blender, ribbon blender, or other suitable blender, or in a Farrel Continuous Mixer (FCM™).

Blending may also involve a “masterbatch” approach, where the target PAO concentration is achieved by combining neat ethylene copolymer(s) and optionally thermoplastic polyolefins) and fillers and/or additives with an appropriate amount of pre-blended masterbatch (i.e., a blend of the ethylene copolymer, PAO, and optionally the thermoplastic polyolefin and the filler and additives that has been previously prepared at a higher concentration of PAO than desired in the final blend). This is a common practice in polymer processing, typically used for addition of color, additives, and fillers to final compositions. Dispersion (or “letdown”) of the masterbatch may take place as part of a processing step used to fabricate articles, such as in the extruder on an injection molding machine or on a continuous extrusion line, or during a separate compounding step.

Films Prepared from the Blend Composition

Elastic films may be prepared from the blend compositions described herein. The film may be formed by any number of well-known extrusion or co-extrusion techniques. For example, any of the blown or chill roll techniques are suitable. For example, the blend composition may be extruded in a molten state through a flat die and then cooled. Alternatively, the blend composition may be extruded in a molten state through an annular die and then blown and cooled to form a tubular film. The tubular film may be axially slit and unfolded to form a flat film. The films may be unoriented, uniaxially oriented or biaxially oriented.

Multiple-layer films may also be formed using methods well known in the art. For example, layer components may be coextruded through a coextrusion feedblock and die assembly to yield a film with two or more layers adhered together, but differing in composition. Multiple-layer films may also be formed by extrusion coating whereby a substrate material is contacted with the hot molten polymer as the polymer exits the die. For instance, an already formed film may be extrusion coated with a layer of the blend compositions described herein as the latter is extruded through the die. Multiple-layer films may also be formed by combining two or more single layer films prepared as described above. The total thickness of multilayer films may vary based upon the application desired. Those of skill in the art will appreciate that the thickness of individual layers for multilayer films may be adjusted based on desired end use performance, polymer compositions employed, equipment capability, and other like factors. In some embodiments the total unstretched film thickness is about 1.0-100.0 μm. Typically, elastic films have a thickness of about 5-50 μm in most applications.

### Fibers and Nonwoven Compositions

The blend compositions described herein may be useful in meltspun (e.g., meltblown or spunbond) fibers and nonwoven compositions (e.g., fabrics). As used herein, “meltspun nonwoven composition” refers to a composition having at least one meltspun layer, and does not require that the entire composition be meltspun or nonwoven. As used herein, “nonwoven” refers to a textile material that has been produced by methods other than weaving. In nonwoven fabrics, the fibers are processed directly into a planar sheet-like fabric structure and then are either bonded chemically, thermally, or interlocked mechanically (or both) to achieve a cohesive fabric.

In certain embodiments, nonwoven compositions comprising the blend compositions may be described as extensible. “Extensible,” as used herein, means any fiber or nonwoven composition that yields or deforms (i.e., stretches) upon application of a force. While many extensible materials are also elastic, the term extensible also encompasses those materials that remain extended or deformed upon removal of the force. Fabric layers containing the blends described herein are useful as extensible facing layers in combination with an elastic core layer, which may be a film or a nonwoven layer. When an extensible facing layer is used in combination with an elastic core layer, the extensible layer may permanently deform when the elastic layer to which it is attached stretches and retracts, creating a wrinkled or textured outer surface with gives an additional soft feel that is particularly suited for articles in which the facing layer is in contact with a wearer's skin.

The fibers and nonwoven compositions can be formed by any method known in the art. For example, the nonwoven compositions may be produced by a spunmelt process. In certain embodiments herein, the layer or layers of the nonwoven compositions are produced by a spunbond process. When the compositions further comprise one or more elastic layers, the elastic layers may be produced by a meltblown process, by a spunbond or spunlace process, or by any other suitable nonwoven process.

Fibers produced from the blend compositions may have a thickness from about 0.5 to about 10 denier, or from about 0.75 to about 8 denier, or from about 1 to about 6 denier, or from about 1 to about 3 denier. Although commonly referred to in the art and used herein for convenience as an indicator of thickness, denier is more accurately described as the linear mass density of a fiber. A denier is the mass (in grams) of a fiber per 9,000 meters. In practice, measuring 9,000 meters may be both time-consuming and wasteful. Usually, a is sample of lesser length (i.e., 900 meters, 90 meters, or any other suitable length) is weighed and the result multiplied by the appropriate factor to obtain the denier of the fiber.

The fibers may be monocomponent fibers or bicomponent fibers. Preferably, the fibers are monocomponent fibers, meaning that the fibers have a consistent composition throughout their cross-section.

The layer that comprises the blend may have a basis weight of less than 50 g/m² (“gsm”), or less than 40 gsm, or less than 30 gsm, or less than 25 gsm, or less than 20 gsm. The layer that comprises the blend may have a basis weight of from about 1 to about 75 g/m² (“gsm”), or from about 2 to about 50 gsm, or from about 5 to about 35 gsm, or from about 7 to about 25 gsm, or from about 10 to about 25 gsm.

In addition to good extensibility and elongation, fibers comprising the blends described herein may also be used to produce fabrics that have improved aesthetics. For example, the fabrics may have an improved feel and softness. Without being bound by theory, it is believed that fabrics produced using the blends described herein have lower bending modulus, due to lower crystallinity, which improves the softness or feel of the fabric. Fabrics made from fibers comprising the blends described herein may have improved softness, as measured by a Handle-O-Meter.

As used herein, “meltblown fibers” and “meltblown compositions” (or “meltblown fabrics”) refer to fibers formed by extruding a molten thermoplastic material at a certain processing temperature through a plurality of fine, usually circular, die capillaries as molten threads or filaments into high velocity, usually hot, gas streams which attenuate the filaments of molten thermoplastic material to reduce their diameter, which may be to microfiber diameter. Thereafter, the meltblown fibers are carried by the high velocity gas stream and are deposited on a collecting surface to form a web or nonwoven fabric of randomly dispersed meltblown fibers. Such a process is generally described in, for example, U.S. Pat. Nos. 3,849,241 and 6,268,203. The term meltblowing as used herein is meant to encompass the meltspray process.

Commercial meltblown processes utilize extrusion systems having a relatively high throughput, in excess of 0.3 grams per hole per minute (“ghm”), or in excess of 0.4 ghm, or in excess of 0.5 ghm, or in excess of 0.6 ghm, or in excess of 0.7 ghm. The nonwoven compositions may be produced using commercial meltblown processes, preferably a high pressure meltblown process available from Biax-Fiberfilm Corporation, or in test or pilot scale processes.

In a typical spunbond process, polymer is supplied to a heated extruder to melt is and homogenize the polymers. The extruder supplies melted polymer to a spinneret where the polymer is fiberized as passed through fine openings arranged in one or more rows in the spinneret, forming a curtain of filaments. The filaments are usually quenched with air at a low temperature, drawn, usually pneumatically, and deposited on a moving mat, belt or “forming wire” to form the nonwoven composition. See, for example, in U.S. Pat. Nos. 4,340,563; 3,692,618; 3,802,817; 3,338,992; 3,341,394; 3,502,763; and 3,542,615. The term spunbond as used herein is meant to include spunlace processes, in which the filaments are entangled to form a web using high-speed jets of water (known as “hydroentanglement”).

### Elastic Laminates

The blend compositions described herein may be particularly useful in forming a film layer that is part of an elastic laminate. The elastic laminate may comprise at least one elastic film layer containing the blend composition and at least one nonwoven facing layer. For example, in some embodiments the elastic laminate comprises an inner elastic film layer and two outer nonwoven facing layers. The outer nonwoven facing layers may be made from any polymer that is suitable for forming nonwoven facing layers, and for example may be made from polypropylene, propylene-ethylene copolymers, ethylene copolymers, polyethylene, polyethylene-terephthalate blends (PET), and blends thereof.

A typical laminate or composite has three or more layers, with the elastic film layer(s) (“F”) sandwiched between two or more outer fabric layers that may be spunbonded layers (“S”), meltblown layers (“M”), or spunlace layers (“L”). Examples of laminate combinations include, but are not limited to SFS, MFS, LFL, SFM, SFL, MFL, SSMFMSS, SMFMS, and SMMSS composites. Composites can also be made of the meltblown or spunbond nonwovens of the invention with other materials, either synthetic or natural, to produce useful articles.

The nonwoven laminate composition may comprise one or more elastic film layers comprising the inventive blend composition and further comprise one or more nonwoven facing layers as described herein positioned on one or both sides of the elastic layer(s). In some embodiments, the film is made in a first process and then the roll of film is laminated to nonwoven facing layers, for example, by pressing the layers through a nip and using heat and pressure to bond the nonwoven layers to the film layers, or by ultrasonic bonding, or by using a hot melt adhesive. In some embodiments, the nonwoven laminate is made in an extrusion lamination process where the film layer is extruded onto a pre-existing nonwoven fabric layer. In some embodiments, the nonwoven laminate is made by forming the nonwoven layer directly onto the film layer.

The nonwoven products described above may be used in many articles such as hygiene products including, but not limited to, diapers, feminine care products, and adult incontinent products. The nonwoven products may also be used in medical products such as sterile wrap, isolation gowns, operating room gowns, surgical gowns, surgical drapes, first aid dressings, and other disposable items. In particular, the nonwoven products may be useful as facing layers for medical gowns, and allow for extensibility in the elbow area of the gown. The nonwoven products may also be useful in disposable protective clothing, and may add toughness to elbow and knee regions of such clothing. The nonwoven products may also be useful as protective wrapping, packaging or wound care. The nonwoven products may also be useful in geotextile applications, as the fabric may have improved puncture resistance in that the fabric will deform instead of puncture.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

The following ethylene copolymers were used in control compositions C1 and C2 as well as in examples E1 through E8. The ethylene copolymers (ECP) 1 and 2 are commercially available Dow Infuse™ grades 9507 and 9107 respectively. ECP-1 and ECP-2 are ethylene-octene copolymers. Table 1 lists properties for ECP-1 and ECP-2.

TABLE 1
Ethylene Copolymer Properties

| | Melt Index | | | | | | Tensile | |
|---|---|---|---|---|---|---|---|---|
| | (2.16 kg @ | | | | | | Modulus | Compression |
| | 190° C.) | Density | Tm | Tg | ΔTm, g | Hardness | (100% Secant) | Set |
| Grade | dg/min | g/cm³ | ° C. | ° C. | ° C. | (Shore A) | MPa | (70° C.) % |
| ECP-1 | 5 | 0.866 | 123 | −58 | 181 | 60 | 1.5 | 70 |
| ECP-2 | 1 | 0.866 | 120 | −58 | 178 | 60 | 1.6 | 49 |

The following polyalphaolefin was used in examples E1 through E8 as described herein and had the properties described in Table 2.

TABLE 2
PAO Properties

| | | | | | | Flash | |
|---|---|---|---|---|---|---|---|
| | | | | | Pour | Point | |
| | SG @ | KV @ | KV @ | | Point, | (COC) | |
| | 15.6° C. | 100° C. | 40° C. | VI | ° C. | ° C. | Mw |
| PAO- | 0.835 | 10.0 cSt | 66 cSt | 137 | −48 | 266 | less than |
| 1 | | | | | | | 1000 g/ |
| | | | | | | | mole |

The following propylene-based polymer was used in example E8 as described herein. The propylene-based polymer (PP-1) is commercially available ExxonMobil Vistamaxx™ grade 6202. Vistamaxx™ 6202 contains propylene-derived units and 15 wt % ethylene-derived units and has the following typical properties: density of 0.863 g/cc (ASTM D1505), melt index (MI) at 2.16 kg at 190° C. of 9.1 g/10 min (ASTM D1238), melt mass-flow rate (MFR) at 2.16 kg at 230° C. of 20 g/10 min, a Shore A hardness of 66 (ASTM D2240), and a Vicat softening temperature of 47.2° C. Table 3 lists properties for PP-1.

Example blend compositions E1 through E8 were prepared in a Brabender mixer using a batch size of 250 gm. ECP-1 and/or 2 was charged into the cavity of the Brabender that was pre-heated to about 160° C. The rotor rpm was maintained at 50 rpm to melt and homogenize the polymer in the mixer. PAO-1 resin that was pre-weighed to provide the desired wt % PAO-1 for each example blend composition was injected via syringe into the Brabender cavity after homogenization of the polymer. Mixing was continued for 3 minutes at constant rpm after addition of PAO-1, at which time the mixer was stopped and the blend removed. The blend was cooled to ambient conditions, and separated by hand into smaller fragments for ease of handling. The blend samples were compression molded and tested for physical properties.

The blend samples were tested for elastic performance via hysteresis cycle testing. Hysteresis testing was conducted using tensile specimens extended at a cross head speed of 508 mm/min or 20 inches/min. The specimen was extended to 100% extension and then returned to zero load without any hold. The strain value at zero load on the return is recorded as permanent set. Other important features of this test are the loads at 50% and 100% extension (top load), the area under the load/un-load curve normalized to the load curve (mechanical hysteresis) and the load at 50% extension on the return (retractive force). Five specimens were tested from each composition and the average value was recorded.

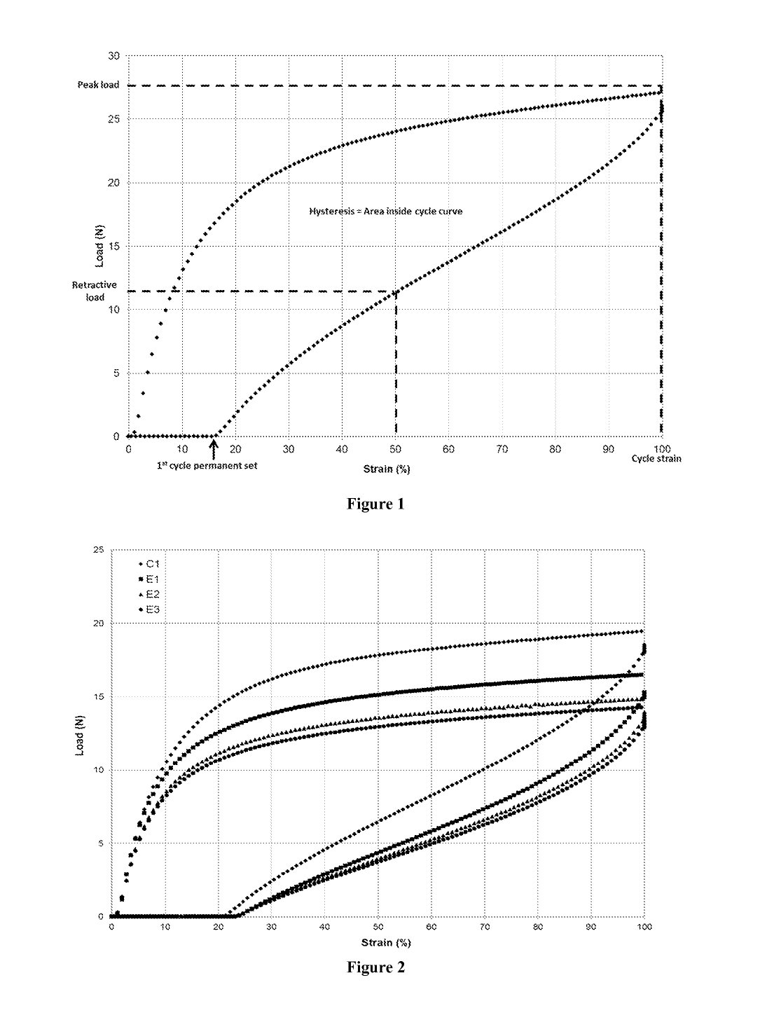

As illustrated in FIG. 1, the cycle strain is defined as the maximum strain attained during the hysteresis cycle testing. For example, for a 100% cycle, the cycle strain is 100%. The peak load is defined as the maximum load force measured at the cycle strain. The 50% load is defined as the load force measured at 50% of the cycle strain. The retractive load is defined as the unloading force measured during the unloading portion of the cycle at 50% of the cycle strain. The 1^{st}-cycle permanent set is defined as the strain upon which the 2^{nd}-cycle loading reached a nominal load of 4 g_{f}. Mechanical hysteresis is defined as the area inside of the hysteresis curve normalized to the area of the load curve and represents the amount of applied energy lost or the amount of unrecoverable energy per initial gauge length. The lower the permanent set and mechanical hysteresis value, the more elastic is the material. Tables 3, 4, and 5 list the hysteresis test results for the control compositions C1 and C2 and the example blend compositions.

TABLE 3

| Example | | C1 | E1 | E2 | E3 |
|---|---|---|---|---|---|
| ECP-1 | wt % | 100.0 | 95.0 | 93.0 | 90.0 |
| PAO-1 | wt % | 0 | 5.0 | 7.0 | 10.0 |
| Total | wt % | 100 | 100 | 100 | 100 |
| Hysteresis First Cycle | | | | | |
| (Average of 3 Samples) | | | | | |
| Top Load at 50% Strain | N | 17.8 | 15.1 | 13.2 | 12.9 |
| Top Load at 100% Strain | N | 19.5 | 16.5 | 14.5 | 14.3 |
| Retractive Force (Unload) | N | 6.5 | 4.4 | 3.9 | 3.7 |
| at 50% Strain | | | | | |
| Load Loss | % | 64 | 71 | 71 | 71 |
| Permanent Set | % | 20.5 | 23.3 | 23.2 | 23.1 |
| Mechanical Hysteresis | % | 59 | 65 | 64 | 65 |
| Hysteresis Second Cycle | | | | | |
| (Average of 3 Samples) | | | | | |
| Top Load at 50% Strain | N | 13.0 | 10.0 | 8.6 | 8.4 |
| Top Load at 100% Strain | N | 19.0 | 16.1 | 14.2 | 13.9 |
| Retractive Force (Unload) | N | 6.2 | 4.2 | 3.7 | 3.6 |
| at 50% Strain | | | | | |
| Load Loss | % | 52 | 58 | 5.7 | 58 |
| Permanent Set | % | 13.3 | 15.1 | 14.9 | 15.2 |
| Mechanical Hysteresis | % | 43 | 47 | 47 | 47 |

As shown in Table 3, the 50% loads of example blends E1 through E3 (with increasing PAO-1 concentration) were respectively 15% (15.1 N), 25%, and 27% lower than the 50% load of control C1 (17.8 N) during the 100% hysteresis first cycle. Similarly, the 50% loads were respectively 23%, 33%, and 35% lower during the second hysteresis cycle. The peak load over both hysteresis cycles for the example blends of ECP-1 with PAO-1 were 15%, 25%, and 27% lower than for the control composition C1 without PAO-1.

Additionally, the elasticity of the blends with PAO-1 was not significantly affected as evidenced by the 2% to 3% increase in permanent set and 4% to 5% increase in mechanical hysteresis. Therefore, the compositions made with PAO-1 exhibited a lower load response without significantly sacrificing elasticity. Thus, the E1 through E3 compositions exhibited softer stretch relative to the C1 composition without sacrificing overall tensile strength. FIG. 2 illustrates the hysteresis response curves for the blends described in Table 3.

TABLE 4

| Example | | C2 | E4 | E5 | E6 |
|---|---|---|---|---|---|
| ECP-2 | wt % | 100 | 95.0 | 93.0 | 90.0 |
| PAO-1 | wt % | 0 | 5.0 | 7.0 | 10.0 |
| Total | wt % | 100 | 100 | 100 | 100 |
| Hysteresis First Cycle | | | | | |
| (Average of 3 Samples) | | | | | |
| Top Load at 50% Strain | N | 23.2 | 21.8 | 21.4 | 20.0 |
| Top Load at 100% Strain | N | 26.9 | 24.4 | 23.9 | 22.5 |
| Retractive Force (Unload) | N | 11.3 | 8.8 | 8.6 | 7.9 |
| at 50% Strain | | | | | |
| Load Loss | % | 53 | 59.9 | 60.0 | 60.4 |
| Permanent Set | % | 15.6 | 17.8 | 17.7 | 17.7 |
| Mechanical Hysteresis | % | 49 | 55.4 | 55.5 | 55.7 |
| Hysteresis Second Cycle | | | | | |
| (Average of 3 Samples) | | | | | |
| Top Load at 50% Strain | N | 18.5 | 15.8 | 15.4 | 14.3 |
| Top Load at 100% Strain | N | 26.4 | 24.0 | 23.4 | 22.0 |
| Retractive Force (Unload) | N | 11.0 | 8.4 | 8.3 | 7.6 |
| at 50% Strain | | | | | |
| Load Loss | % | 40 | 46.7 | 46.5 | 46.6 |
| Permanent Set | % | 9.7 | 10.9 | 10.8 | 11.0 |
| Mechanical Hysteresis | % | 35 | 39.3 | 39.3 | 39.4 |

As shown in Table 4, the 50% loads of example blends E4 through E6 (with increasing PAO-1 concentration) were respectively 6% (21.8 N), 7%, and 14% lower than the 50% load of control C2 (23.2 N) during the 100% hysteresis first cycle. Similarly, the 50% loads were respectively 14%, 17%, and 23% lower during the second hysteresis cycle. The peak load over both hysteresis cycles for the example blends of ECP-2 with PAO-1 were 9%, 11%, and 16% lower than for the control composition C2 without PAO-1.

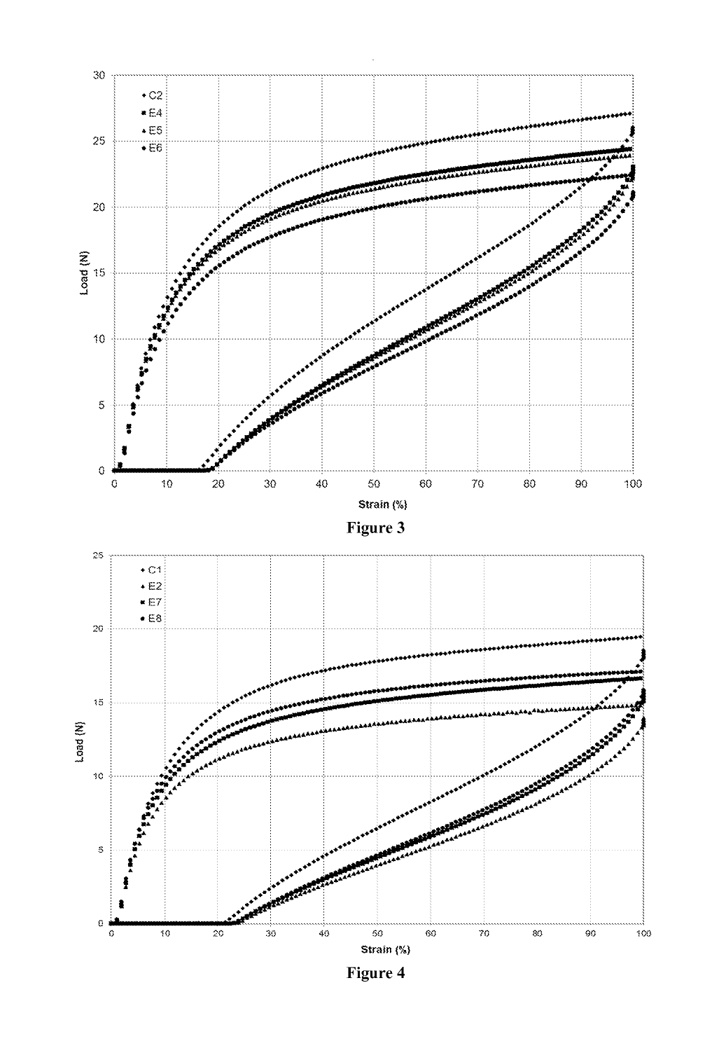

Additionally, the elasticity of the blends with PAO-1 was not significantly affected as evidenced by the 1% to 2% increase in permanent set and 4% to 5% increase in mechanical hysteresis. Therefore, the compositions made with PAO-1 exhibited a lower load response without sacrificing elasticity. Thus, the E4 through E6 compositions exhibited softer stretch relative to the C2 composition without significantly sacrificing elasticity. FIG. 3 illustrates the hysteresis response curves for the blends described in Table 4.

TABLE 5

| Example | | C1 | E2 | E7 | E8 |
|---|---|---|---|---|---|
| ECP-1 | wt % | 100.0 | 93.0 | 83.0 | 83.0 |
| ECP-2 | wt % | 0 | 0 | 10.0 | 0 |
| PP-1 | wt % | 0 | 0 | 0 | 10.0 |
| PAO-1 | wt % | 0 | 7.0 | 7.0 | 7.0 |
| Total | wt % | 100 | 100 | 100 | 100 |
| Hysteresis First Cycle | | | | | |
| (Average of 3 Samples) | | | | | |
| Top Load at 50% Strain | N | 17.8 | 15.1 | 15.1 | 15.8 |
| Top Load at 100% Strain | N | 19.5 | 16.5 | 16.7 | 17.1 |
| Retractive Force (Unload) | N | 6.5 | 4.4 | 4.5 | 4.7 |
| at 50% Strain | | | | | |
| Load Loss | % | 64 | 71 | 70.5 | 70.5 |
| Permanent Set | % | 20.5 | 23.3 | 22.6 | 22.8 |
| Mechanical Hysteresis | % | 59 | 65 | 64.0 | 64.1 |
| Hysteresis Second Cycle | | | | | |
| (Average of 3 Samples) | | | | | |
| Top Load at 50% Strain | N | 13.0 | 10.0 | 9.9 | 10.3 |
| Top Load at 100% Strain | N | 19.0 | 16.1 | 16.2 | 16.6 |
| Retractive Force (Unload) | N | 6.2 | 4.2 | 4.3 | 4.4 |
| at 50% Strain | | | | | |
| Load Loss | % | 52 | 58 | 56.8 | 57.0 |
| Permanent Set | % | 13.3 | 15.1 | 14.7 | 14.9 |
| Mechanical Hysteresis | % | 43 | 47 | 46.6 | 46.6 |

As shown in Table 5, the findings from previous examples E1 through E6 held true for example E7, a PAO-1 containing blend of two ethylene copolymers ECP-1 and ECP-2, and for example E8, a PAO-1 containing blend of ethylene copolymer (ECP-1) and propylene polymer (PP-1). The 50% loads of example blends E7 and E8 were respectively 15% (15.1 N) and 11% (15.8 N) lower than the 50% load of control C1 (17.8 N) during the 100% hysteresis first cycle. Likewise, the 50% loads were 24% and 20% lower respectively during the 100% hysteresis second cycle. Similarly, the peak load over both hysteresis cycles for the example blends E7 and E8 with PAO-1 were lower than for the control composition C1 without PAO-1.

Additionally, the elasticity of the blends with PAO-1 was not significantly affected as evidenced by the modest increase in permanent set (about 3%) and mechanical hysteresis (about 4.5%). Therefore, the multiple polymer blend compositions E7 and E8 made with PAO-1 exhibited a lower load response without significantly sacrificing elasticity. Thus, the E7 and E8 compositions exhibited softer stretch relative to the C1 composition. FIG. 4 illustrates the hysteresis response curves for the blends described in Table 5.

Having described the various aspects of the compositions herein, further specific embodiments of the invention include those set forth in the following paragraphs.

Embodiment A: A polymer composition comprising: (a) an ethylene copolymer, where the ethylene copolymer comprises greater than 50 mole % ethylene and has (i) a density less than or equal to 0.89 g/cm³, (ii) a Tm of at least 100° C., (iii) a Melt index less than or equal to 7 dg/min, and (iv) a ΔTm,g of at least 140° C.; and (b) from 0.5 wt % to 60 is wt % polyalphaolefin, where the polyalphaolefin has (i) a Kinematic viscosity (Kv) at 100° C. of from 3 to 3000 cSt, (ii) a flash point of at least 200° C., and (iii) a pour point less than or equal to −10° C.

Embodiment B: The polymer composition of Embodiment A, wherein the polymer composition has a 50% loading force during a 100% hysteresis cycle at least 6% lower than a similar composition containing the same ethylene copolymer except that the similar composition contains no polyalphaolefin and the two compositions are tested under exactly the same conditions.

Embodiment C: The polymer composition of any one of Embodiments A to B, wherein the polymer composition has a 100% loading force during a 100% hysteresis cycle at least 9% lower than a similar composition containing the same ethylene copolymer except that the similar composition contains no polyalphaolefin and the two compositions are tested under exactly the same conditions.

Embodiment D: The polymer composition of any one of Embodiments A to C, wherein the polyalphaolefin comprises oligomers of a-olefins having carbon number from 5 to 24.

Embodiment E: The polymer composition of any one of Embodiments A to D, wherein the polyalphaolefin comprises oligomers of 1-octene, 1-decene, 1-dodecene, and blends thereof.

Embodiment F: The polymer composition of any one of Embodiments A to E, wherein the polyalphaolefin has a weight average molecular weight (Mw) of less than 5,000 g/mole.

Embodiment G: The polymer composition of any one of Embodiments A to F, wherein the polyalphaolefin has a kinematic viscosity (KV) at 100° C. of from 5 to 1000 cSt.

Embodiment H: The polymer composition of any one of Embodiments A to G, wherein the polyalphaolefin has a kinematic viscosity (KV) at 100° C. of from 7 to 100 cSt.

Embodiment I: The polymer composition of any one of Embodiments A to H, wherein the polymer composition comprises 1 to about 40 wt % of the polyalphaolefin and 60 to 99 wt % of the ethylene copolymer.

Embodiment J: The polymer composition of any one of Embodiments A to I, wherein the polymer composition comprises 1 to 20 wt % of the polyalphaolefin and 80 to 99 wt % of the ethylene copolymer.

Embodiment K: The polymer composition of any one of Embodiments A to J, is wherein the polymer composition additionally comprises 25 wt % or less of one or more polymer modifiers.

Embodiment L: The polymer composition of any one of Embodiments A to K, wherein the polymer composition additionally comprises 25 wt % or less of a propylene-based polymer.

Embodiment M: The polymer composition of any one of Embodiments A to L, wherein the polymer composition consists essentially of the polyalphaolefin and the ethylene copolymer.

Embodiment N: A film comprising the polymer composition of any one of Embodiments A to M.

Embodiment O: A laminate composition having at least one elastic film layer, wherein the elastic layer comprises the film of Embodiment N.

Embodiment P: The laminate composition of Embodiment O, wherein the laminate composition further comprises one or more nonwoven facing layers disposed on either side of the elastic layer.

For purposes of convenience, various specific test procedures are identified above for determining certain properties. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims.

Certain embodiments and features have been described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

As used herein, the phrases “substantially no,” and “substantially free of” are intended to mean that the subject item is not intentionally used or added in any amount, but may be present in very small amounts existing as impurities resulting from environmental or process conditions.

To the extent a term used in a claim is not defined, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A polymer composition comprising:
(a) an ethylene copolymer, where the ethylene copolymer comprises greater than 50 mole % ethylene and has
(i) a density less than or equal to 0.89 g/cm³,
(ii) a Tm of at least 100° C.,
(iii) a Melt index less than or equal to 7 dg/min, and
(iv) a ΔTm,g of at least 140° C.; and
(b) from 0.5 wt % to 60 wt % polyalphaolefin, where the polyalphaolefin has
(i) a Kinematic viscosity (Kv) at 100° C. of from 3 to 3000 cSt
(ii) a flash point of at least 200° C., and
(iii) a pour point less than or equal to −10° C.

2. The polymer composition of claim 1, wherein the polymer composition has a 50% loading force during a 100% hysteresis cycle at least 6% lower than a similar composition containing the same ethylene copolymer except that the similar composition contains no polyalphaolefin and the two compositions are tested under the same conditions.

3. The polymer composition of claim 1, wherein the polymer composition has a 100% loading force during a 100% hysteresis cycle at least 9% lower than a similar composition containing the same ethylene copolymer except that the similar composition contains no polyalphaolefin and the two compositions are tested under the same conditions.

4. The polymer composition of claim 1, wherein the polyalphaolefin comprises oligomers of α-olefins having carbon number from 5 to 24.

5. The polymer composition of claim 1, wherein the polyalphaolefin comprises oligomers of 1-octene, 1-decene, 1-dodecene, and blends thereof.

6. The polymer composition of claim 1, wherein the polyalphaolefin has a weight average molecular weight (Mw) of less than 5,000 g/mole.

7. The polymer composition of claim 1, wherein the polyalphaolefin has a kinematic viscosity (KV) at 100° C. of from 5 to 1000 cSt.

8. The polymer composition of claim 1, wherein the polyalphaolefin has a kinematic viscosity (KV) at 100° C. of from 7 to 100 cSt.

9. The polymer composition of claim 1, wherein the polymer composition comprises 1 to about 40 wt % of the polyalphaolefin and 60 to 99 wt % of the ethylene copolymer.

10. The polymer composition of claim 1, wherein the polymer composition comprises 1 to 20 wt % of the polyalphaolefin and 80 to 99 wt % of the ethylene copolymer.

11. The polymer composition of claim 1, wherein the polymer composition additionally comprises 25 wt % or less of one or more polymer modifiers.

12. The polymer composition of claim 1, wherein the polymer composition additionally comprises 25 wt % or less of a propylene-based polymer.

13. The polymer composition of claim 1, wherein the polymer composition consists essentially of the polyalphaolefin and the ethylene copolymer.

14. A film comprising the polymer composition of claim 1.

15. A laminate composition having at least one elastic film layer, wherein the elastic layer comprises the film of claim 14.

16. The laminate composition of claim 15, wherein the laminate composition further comprises one or more nonwoven facing layers disposed on either side of the elastic layer.
